(19) United States
(12) Patent Application Publication
(10) Pub. No.: US 2003/0033476 A1
(43) Pub. Date: Feb. 13, 2003

(54) Image forming apparatus and hard disc drive data transfer method for image forming apparatus

(75) Inventor: Takeru Ono, Kawasaki-shi (JP)

Correspondence Address: Johnny A. Kumar, FOLEY & LARDNER, Washington Harbour, 3000 K Street, N.W., Suite 500, Washington, DC, 20007-5109, US

(73) Assignee: TOSHIBA TEC KABUSHIKI KAISHA

(21) Appl. No.: 09/922,705

(22) Filed: Aug. 7, 2001

(51) Int. Cl. G06F 13/00

(52) U.S. Cl. 711/113

(57) ABSTRACT

When data is transferred between a memory and a hard disk drive, a file transfer control section issues an instruction to a file system by designating an area in the memory, and the file system designates a page memory area in an IDE driver. The IDE driver comprises means for determining whether the memory area designated by the file system is a cache memory or a non-cache memory, and a relay buffer assigned to the non-cache memory. If the memory area designated by the file system is the cache memory, DMA transfer between the hard disk drive and the relay buffer and data transfer between the relay buffer and the designated memory area is performed. If the memory area designated by the file system is the non-cache memory, DMA transfer between the hard disk drive and the designated memory area is performed.

### BACKGROUND OF THE INVENTION

The present invention relates to an image forming apparatus equipped with a hard disk drive, wherein image data read by a scanner section is temporarily stored in the hard disk drive, and the image data is read out of the hard disk drive to produce an image by a printer section.

In general terms, image forming apparatuses adopting hard disk drives (“HDD”) as temporary image data storage media include digital copying machines, printers, facsimiles, and multi-functional peripherals (MFP) having functions of these devices. In the MFP, the HDD stores scan data, printer data, facsimile transmission/reception data, etc.

The performance of the system in the HDD-equipped apparatus varies greatly depending on the read/write performance of the HDD. In particular, in cases where color images are treated or plural functions are performed simultaneously, as in the MFP, the amount of data to be processed at a time is large, and the enhancement of the read/write performance of the HDD is very important.

### BRIEF SUMMARY OF THE INVENTION

The object of the present invention is to provide an image forming apparatus and an image forming method, wherein an over-head is prevented from occurring at the time of HDD access, and data transfer between an HDD and a memory is efficiently performed, thereby enhancing the HDD access performance.

In order to achieve the object, the present invention provides an image forming apparatus having a memory that stores image data, and a hard disk drive that stores an image data file, the apparatus comprising: designation means for designating a memory area of the memory when data is transferred between the memory and the hard disk drive; a relay buffer provided in the memory; determination means for determining whether the memory area designated by the designation means is a cache memory or a non-cache memory; first transfer means for controlling, when the determination means has determined that the memory area is the cache memory, DMA transfer between the hard disk drive and the relay buffer, and data transfer between the relay buffer and the designated memory area; and second transfer means for controlling, when the determination means has determined that the memory area is the non-cache memory, DMA transfer between the hard disk drive and the designated memory area.

The invention also provides an image forming apparatus having a memory that stores image data, and a hard disk drive that stores an image data file, the apparatus comprising: a buffer serving as a non-cache memory set in the memory; designation means for designating a memory area of the buffer when data is transferred between the memory and the hard disk drive; determination means for determining whether the memory area designated by the designation means is a cache memory or a non-cache memory; and transfer means for controlling, when the determination means has determined that the memory area is the non-cache memory, DMA transfer between the hard disk drive and the buffer.

The invention also provides a hard disk drive data transfer method for an image forming apparatus having a memory that stores image data, and a hard disk drive that stores an image data file, the method comprising: designating a memory area of the memory when data is transferred between the memory and the hard disk drive; determining whether the designated memory area is a cache memory or a non-cache memory; performing, when the memory area is determined to be the cache memory, DMA transfer between the hard disk drive and a relay buffer preset in the memory, and data transfer between the relay buffer and the designated memory area; and performing, when the memory area is determined to be the non-cache memory, DMA transfer between the hard disk drive and the designated memory area.

### BRIEF DESCRIPTION OF THE SEVERAL VIEWS OF THE DRAWING

FIG. 1 schematically shows an internal structure of a digital copying machine for forming a copy image of a color image according to the image forming apparatus of the present invention;

FIG. 2 is a block diagram showing a hardware configuration in the digital copying machine;

FIG. 3 shows a prior-art software configuration for data transfer between a page memory and a hard disk drive; and

FIG. 4 shows a software configuration according to an embodiment of the present invention.

### DETAILED DESCRIPTION OF THE INVENTION

An embodiment of the present invention will now be described with reference to the accompanying drawings.

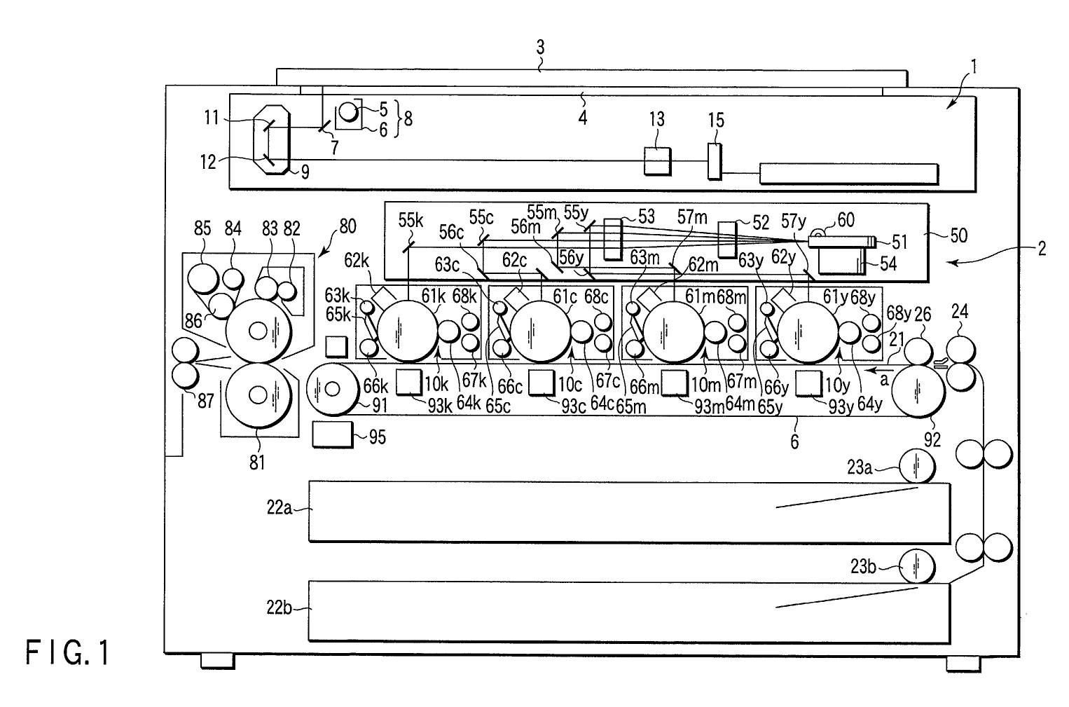

FIG. 1 schematically shows an internal structure of a digital copying machine for forming a copy image of a color image according to the image forming apparatus of the present invention. In general terms, the digital copying machine comprises a color scanner section 1 serving as image reading means for reading a color image on an original, and a color printer section 2 serving as image forming means for forming a copy image of the read color image.

The color scanner section 1 has an original table cover 3 on its upper part, and an original table 4 formed of transparent glass and disposed to face the original table cover 3 in the closed state. An original is placed on the original table 4. Below the original table 4, there are provided an exposure lamp 5 for illuminating the original placed on the original table 4; a reflector 6 for converging light from the exposure lamp 5 onto the original; and a first mirror 7 for deflecting the reflection light from the original to the left in the figure. The exposure lamp 5, reflector 6 and first mirror 7 are fixed to a first carriage 8. The first carriage 8 is driven by a pulse motor (not shown) by means of a toothed belt (not shown), etc. so that the first carriage 8 may be moved in parallel along the lower surface of the original table 4.

A second carriage 9 is disposed on the left side (in the figure) of the first carriage 8, that is, on the side to which reflection light from the first mirror 7 is guided. The second carriage 9 is movable in parallel to the original table 4 by means of a drive mechanism (not shown) (e.g. a toothed belt and a DC motor). The second carriage 9 comprises a second mirror 11 for downwardly (in the figure) deflecting the reflection light from the original which has been guided by the first mirror 7, and a third mirror 12 for deflecting the reflection from the second mirror 11 to the right in the figure. The second mirror 11 and third mirror 12 are disposed at right angles to each other. The second carriage 9 follows the movement of the first carriage 8 and moves in parallel to the original table 4 at a speed equal to half the speed of the first carriage 8.

A focusing lens 13 for focusing the reflection light from the third mirror 12 at a predetermined magnification is disposed in a plane including an optical axis of the light deflected by the second and third mirrors 11 and 12. A CCD color image sensor (photoelectric conversion element) 15 for converting the reflection light converged by the focusing lens 13 to an electric signal is disposed in a plane substantially perpendicular to the optical axis of the light traveling through the focusing lens 13.

If light from the exposure lamp 5 is converged onto the original placed on the original table 4 by means of the reflector 6, the reflection light from the original is made incident on the color image sensor 15 via the first mirror 7, second mirror 11, third mirror 12 and focusing lens 13. The color image sensor 15 converts the incident light to electric signals of the three primary colors, R (red), G (green) and B (blue).

The color printer section 2 has first to fourth image forming units 10y, 10m, 10c and 10k for producing images of four colors, yellow (Y), magenta (M), cyan (C) and black (K), which are color-separated according to a well-known subtractive color mixing process.

A convey mechanism 20 is disposed below the image forming units 10y, 10m, 10c and 10k. The convey mechanism 20 includes a convey belt 21 serving as convey means for conveying color images produced by the respective image forming units in a direction indicated by an arrow a. The convey belt 21 is passed between a driving roller 91 rotated by a motor (not shown) in the direction of arrow a and a driven roller 92 disposed apart from the driving roller 91 by a predetermined distance. The convey belt 21 is endlessly run in the direction of arrow a at a fixed speed. The image forming units 10y, 10m, 10c and 10k are arranged in tandem in the direction of conveyance of the convey belt 21.

Each of the image forming unit 10y, 10m, 10c and 10k includes a photosensitive drum 61y, 61m, 61c, 61k serving as an image carrying body. The photosensitive drums 61y, 61m, 61c and 61k have outer peripheral surfaces which are rotatable in the same direction at points of contact with the convey belt 21. The photosensitive drums 61y, 61m, 61c and 61k are rotated by a motor (not shown) at a predetermined speed.

The photosensitive drums 61y, 61m, 61c and 61k are disposed to have their axes arranged at regular intervals from one another and in a direction perpendicular to the direction in which images are conveyed by the convey belt 21. In the description below, assume that the axial direction of each photosensitive drum 61y, 61m, 61c, 61k is referred to as a main scan direction (second direction), and the rotational direction of each photosensitive drum 61y, 61m, 61c, 61k, that is, the direction of running of the convey belt 21 (the direction of arrow a), is referred to as a sub-scan direction (first direction).

Around each of the photosensitive drum 61y, 61m, 61c and 61k, the following elements are disposed in order in the rotational direction: a charging device 62y, 62m, 62c, 62k serving as charging means, extended in the main scan direction; a destaticizer 63y, 63m, 63c, 63k; a developing roller 64y, 64m, 64c, 64k serving as developing means, similarly extended in the main scan direction; a lower stirring roller 67y, 67m, 67c, 67k; an upper stirring roller 68y, 68m, 68c, 68k; a transfer device 93y, 93m, 93c, 93k serving as transfer means, similarly extended in the main scan direction; a cleaning blade 65y, 65m, 65c, 65k similarly extended in the main scan direction; and a waste toner recovering screw 66y, 66m, 66c, 66k.

Each transfer device 93y, 93m, 93c, 93k is disposed at such a position as to sandwich the convey belt 21 between itself and the photosensitive drum 61y, 61m, 61c, 61k, that is, inside the convey belt 21. In addition, an exposure point by an exposure device 50 (to be described later) is formed on that portion of the outer peripheral surface of each photosensitive drum 61y, 61m, 61c, 61k, which lies between the charging device 62y, 62m, 62c, 62k and the developing roller 64y, 64m, 64c, 64k.

Sheet cassettes 22a, 22b containing paper sheets P as image formation media, on which images formed by the image forming units 10y, 10m, 10c, 10k are to be transferred, are disposed below the convey mechanism 20.

A pick-up roller 23a, 23b is disposed at one end of each of the sheet cassettes 22a, 22b and on a side close to the driven roller 92. The pick-up roller 23a, 23b picks up sheets P one by one from the uppermost one from the sheet cassette 22a, 22b. Register rollers 24 are disposed between the pickup rollers 23a, 23b and the driven roller 92. The register rollers 24 register and align a leading edge of the sheet P picked up from the sheet cassette 22a, 22b with a leading edge of a y-toner image formed on the photosensitive drum 61y of the image forming unit 10y.

Toner images formed on the other photosensitive drums 61y, 61m and 61c are brought to respective transfer positions in accordance with the transfer timing of the sheet P conveyed on the convey belt 21.

An attraction roller 26 for providing an electrostatic attraction force to the sheet P conveyed at the predetermined timing via the register rollers 24 is disposed between the register rollers 24 and the first image forming unit 10y, and near the driven roller 92, that is, substantially over the outer peripheral surface of the driven roller 92 with the convey belt 21 interposed. The axis of the attraction roller 26 and the axis of the driven roller 92 are set to be parallel to each other.

A position error sensor 96 for sensing a position of the image formed on the sheet P on the convey belt 21 is disposed in a region at one end of the convey belt 21, and near the driving roller 91, that is, substantially over the outer peripheral surface of the driving roller 91 with the convey belt 21 interposed. The position error sensor 96 comprises, for example, a light transmission type or a light reflection type optical sensor.

A convey belt cleaning device 95 for removing toner adhering to the convey belt 21 or paper dust of the sheet P is disposed at the outer peripheral surface of the driving roller 91, in contact with the convey belt 21 on the downstream side of the position error sensor 96.

A fixing device 80 is disposed in a region to which the sheet P conveyed by the convey belt 21 and separated from the driving roller 91 is delivered. The fixing device 80 heats the sheet P at a predetermined temperature, melts the toner image transferred on the sheet P, and fixes the toner image on the sheet P. The fixing device 80 comprises a heat roller pair 81, oil apply rollers 82 and 83, a web winding roller 84, a web roller 85, and a web press roller 86. The toner on the sheet P is fixed and the sheet P with the fixed toner image is discharged by a discharge roller pair 87.

The exposure device 50 forms color-separated electrostatic latent images on outer peripheral surfaces of the respective photosensitive drums 61y, 61m, 61c and 61k. The exposure device 50 has a semiconductor laser 60. The light emission from the semiconductor laser 60 is controlled on the basis of image data (y, m, c, k) of respective colors separated by an image processing apparatus 36 (to be described below). A polygon mirror 51 rotated by a polygon motor 54 to reflect and scan laser beams and fθ lenses 52 and 53 for focusing the laser beams reflected by the polygon mirror 51 by correcting their focal points are disposed in the named order along the optical path of the semiconductor laser 60.

First deflection mirrors 55y, 55m, 55c and 55k for deflecting the respective color laser beams emanating from the fθ lens 53 toward the exposure points on the photosensitive drums 61y, 61m, 61c and 61k, and second and third deflection mirrors 56y, 56m, 56c, 57y, 57m and 57c for further deflecting the laser beams deflected by the first deflection mirrors 55y, 55m and 55c are disposed between the fθ lens 53 and the photosensitive drums 61y, 61m, 61c and 61k.

The laser beam for black is deflected by the first deflection mirror 55k and then directly guided to the photosensitive drum 61k without intervention of other mirrors.

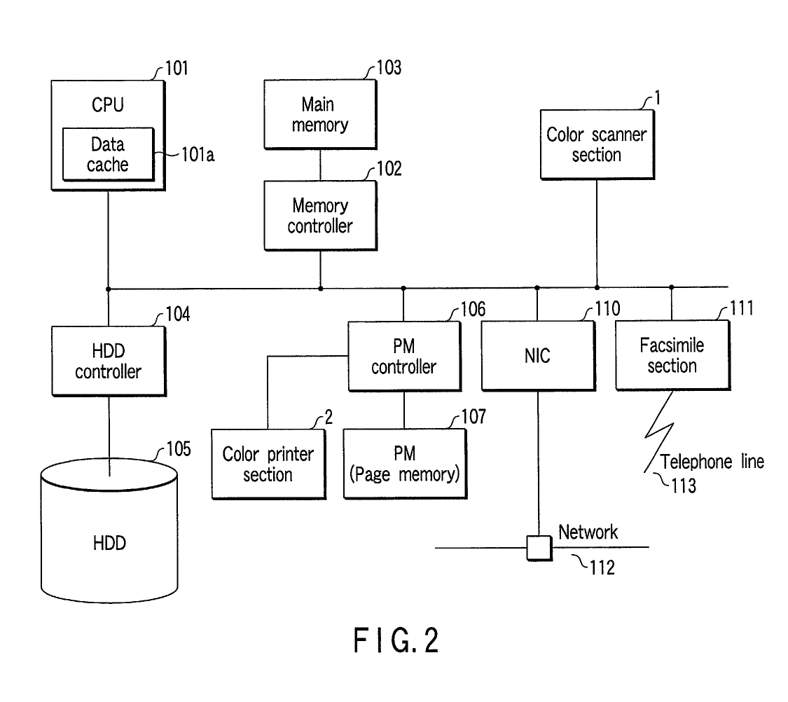

FIG. 2 shows an ordinary hardware configuration in a digital copying machine (hereinafter referred to as “MFP”) shown in FIG. 1.

The MFP comprises a color scanner section 1; a color printer section 2; a CPU 101; a memory controller 102; a main memory 103; an HDD controller 104; a hard disk drive (HDD) 105; a PM controller 106; a page memory (hereinafter “PM”) 107; a network interface controller (hereinafter “NIC”) 110; and a facsimile section 111.

The CPU 101 includes a data cache 101a and controls the entire apparatus.

The memory controller 102 controls input/output of image data in the main memory 103.

The main memory 103 temporarily stores various information.

The HDD controller 104 controls read/write of the HDD 105.

The HDD 105 stores image data from the color scanner section 1, etc.

The PM controller 106 controls read/write of the PM 107 and controls transmission of image data to the printer section 109.

The PM 107 has an area capable of storing image information of plural pages. The PM 107 can store compressed data of image information from the color scanner section 1 in units of a page.

The NIC controls input/output of image data, etc. from a network 112 to which it is connected.

The facsimile section 111 performs facsimile transmission/reception via a telephone line 113.

The operations of the respective functions controlled by the CPU 101 will now be described.

1. Scan Input Operation

(1) Image data read by the color scanner section 1 is input to the PM 107 by the PM controller 106.

(2) Image data on the PM 107 is transferred from the PM 107 to the HDD 105 by the PM controller 106 and HDD controller 104. Alternatively, image data on the PM 107 is compressed on the PM 107 by the PM controller 106, and then transferred to the HDD 105 by the PM controller 106 and HDD controller 104.

2. Print Operation

(1) Image data taken in the HDD 105 is transferred to the PM 107 by the HDD controller 104 and PM controller 106.

(2) If the data transferred to the PM 107 is compressed data, the compressed data is decompressed by the PM controller 106 and developed on the PM 107.

(3) Image data on the PM 107 is transferred to the color printer section 109 by the PM controller 106, and printing thereof is executed.

3. Network Printer Operation

(1) Printer data received from the network 112 is transferred to the main memory 103 via the NIC 110. The data on the main memory 103 is subjected to a RIP (raster image processor) process by the CPU 101 and converted to raster data. In some cases, thereafter, the raster data is converted to compressed data on the main memory 103.

(2) The raster data or compressed data on the main memory 103 is transferred to the HDD 105 by the HDD controller 104.

(3) Printer data in the HDD 105 is printed by the procedure of the print operation in the above item 2.

4. Scan and Transmission Operation of Facsimile

(1) Facsimile transmission data is input to the HDD 105 by the procedure of the scan input operation of the above item 1.

(2) Facsimile transmission data in the HDD 105 is transferred from the HDD 105 to the main memory 103 by the HDD controller 104.

(3) The facsimile section 111 receives facsimile transmission data from the main memory 103 and subjects it to a necessary process for facsimile transmission, and then faxes the data over the telephone line 113.

5. Reception and Print Operation of Facsimile

(1) Facsimile reception data received from the telephone line 113 is processed by the facsimile section 111 and then transferred to the main memory 103.

(2) Facsimile reception data on the main memory 103 is transferred to the HDD 105 by the HDD controller 104.

(3) Facsimile reception data in the HDD 105 is printed by the procedure of the print operation of the above item 2.

A description will now be given of a method of controlling data transfer between the HDD 105 and the memory in the above operations. As mentioned above, the destination/origin of image data transfer is the main memory 103 or the PM 107. In the following description, the PM 107 is described.

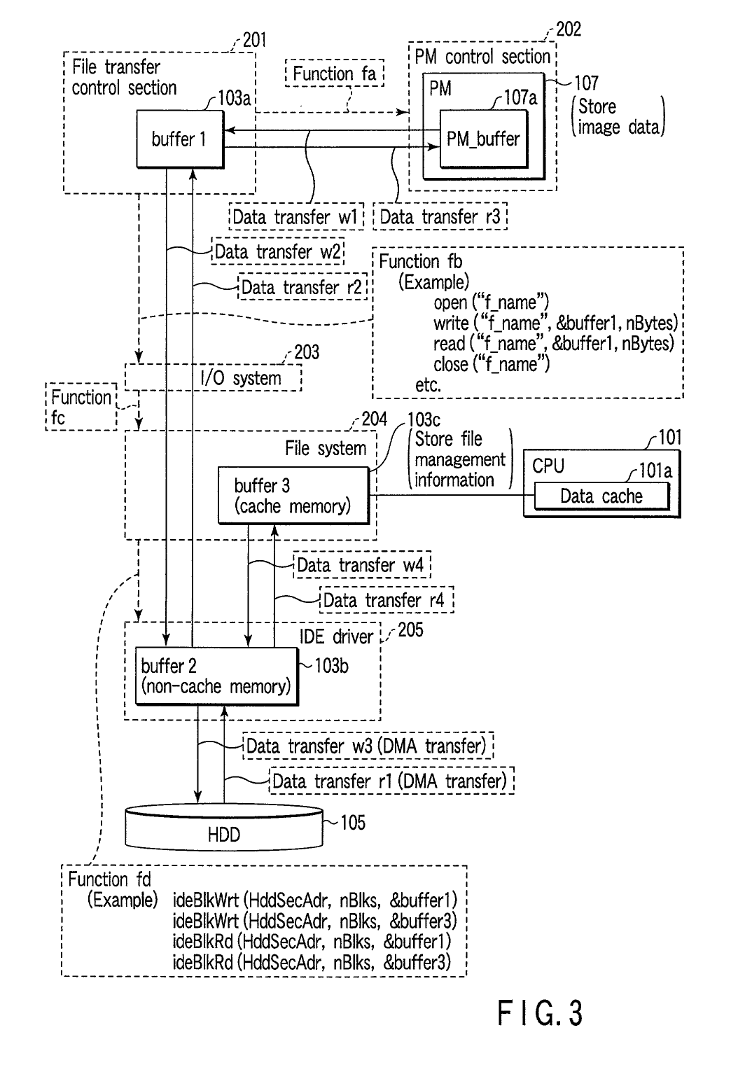

FIG. 3 shows a prior-art software configuration for data transfer between the PM 107 and HDD 105.

In FIG. 3, blocks of broken lines indicate software modules, and blocks of solid lines indicate hardware. Hardware under control of the software modules is shown within the associated software module blocks.

The software modules comprise a file transfer control section 201, a PM control section 202, an I/O system 203, a file system 204 and an IDE driver 205.

The hardware comprises a CPU 101, a data cache 101a provided within the CPU 101, a HDD 105, a PM 107, a PM_buffer 107a provided within the PM 107, and a buffer1 103a, a buffer2 103b and a buffer3 103c provided within a main memory 103.

The file transfer control section 201 issues an instruction to convert various image data to files and to record them in the HDD 105, and an instruction to read out the image data files from the HDD 105.

The PM control section 202 manages data input to the PM 107 and data output from the PM 107, and performs data compression/decompression within the PM 107.

The I/O system 203 is a standard module provided in the OS of the MFP for access to various I/O devices.

The file system 204 is an OS-specific device that is required where the I/O device is a block device such as HDD 105, as in the present embodiment.

The IDE driver 205 is a device driver for directly controlling the HDD 105.

The modules requiring development by device designers according to the original specifications of the MFP are the file transfer control section 201, PM control section 202, and IDE driver 205. The I/O system 203 and file system 204 are standard modules prepared by the OS of the MFP.

In FIG. 3, the buffer1 103a, buffer2 (cache memory) 103b and buffer3 (non-cache memory) 103c are used, respectively, by the modules: the file transfer control section 201, IDE driver 205 and file system 204. These buffer1 103a, buffer2 103b and buffer3 103c are assigned within the main memory 103.

In FIG. 3, the PM_buffer 107a is a buffer used for data transfer by the PM 107 with the outside, and it is assigned to an area of the PM 107.

In this structure, the data to be read/written from/in the HDD 105 is image data on the PM 107 and file management data generated and used by the file system 204. The file management data is information that is necessary for the file system 204 to manage image data files within the HDD 105. In general terms, a FAT (file allocation table), etc. correspond to this.

In order to make the present invention clearer, a description will now be given of [I] HDD write control of image data files, [II] HDD read control of image data files, and [III] HDD read/write control of file management data.

[I] HDD Write Control of Image Data Files

(1) The file transfer control section 201 calls an I/O function (function fb in FIG. 3) to the I/O system 203 in order to generate and open within the HDD 105 a file for saving image data. An example of the name of the I/O function is open(“f_name”). The argument f_name of this function is the name of a file to be generated and opened. This function is reported to the file system 204 through a function fc shown in FIG. 3.

The file system 204 exchanges file management data with the HDD 105 on an as-needed basis (see [III] HDD Read/Write Control of File Management Data, as described below).

(2) The file transfer control section 201 confirms the PM control section 202 as to whether image data to be written in the HDD 105 has been prepared in the PM buffer 107a, and acquires a start address (&PM_buffer) and a transfer byte number (nBytes) of the PM_buffer 107a (according to a function fa in FIG. 3).

(3) Upon confirming the preparation of data in the PM buffer 107a, the file transfer control section 201 transfers data on the transfer byte number nBytes from the PM_buffer 107a to the buffer1 103a of the file transfer control section 201 (data transfer w1 in FIG. 3).

(4) The file transfer control section 201 calls the I/O function to the I/O system 203 in order to write in the HDD 105 the image data within the buffer1 103a, which has been received from the PM 107 (function fb in FIG. 3). An example of the I/O function is write (“f name”, &buffer1, nBytes). The argument f_name of the function is the name of a file within the HDD 105 that is a destination of data transfer. The argument &buffer1 is a start address of the buffer1 103a that is an origin of data transfer, and nBytes is a transfer byte number for transfer to the HDD 105. The file “f name” is generated and opened in the above step (1), and the nBytes is acquired in the above step (2) by the PM control section 202.

(5) The I/O system 203 calls a write instruction function to the file system 204 for the write to the HDD 105 (function fc in FIG. 3).

(6) The file system 204 designates a sector address and a transfer sector number within the HDD 105 to the IDE driver 205, and calls a write instruction function for write to the HDD 105 (function fd in FIG. 3). An example of the name of the function is ideBlkWrt (HddSecAdr, nBlks, &buffer1).

The arguments of the function, HddSecAdr, nBlks, and &buffer1, indicate, respectively, the sector start address and transfer sector number of the HDD 105, which is the destination of transfer, and the start address of the memory, which is the origin of transfer. The arguments, HddSecAdr and nBlks, are determined by the file system 204 on the basis of the file name and transfer byte number delivered from the file transfer control section 201 in the step (4). The argument &buffer1 is the &buffer1 delivered from the file transfer control section 201 as such.

(7) The IDE driver 205 transfers data of sector number nBlks from the buffer1 103a to the buffer2 103b of the IDE driver 205 (data transfer w2 in FIG. 3).

(8) The IDE driver 205 transfers by DMA the data from the buffer2 103b to the HDD 105 (data transfer w3 in FIG. 3). The sector start address of the HDD 105, which is the destination of transfer, is HddSecAdr delivered from the file system 204 in the above step (6).

(9) The steps (2) to (8) are repeated according to the image data size.

(10) The file transfer control section 201 calls the I/O function to the I/O system 203 in order to finish the filing of image data (function fb in FIG. 3). An example of the name of the function is close (“f name”). This function is reported to the file system 204 through the function fc in FIG. 3. The file system 204 exchanges file management data with the HDD 105 on an as-needed basis (see [III] HDD Read/Write Control of File Management Data, as described below).

[II] HDD Read Control of Image Data Files

(1) The file transfer control section 201 calls an I/O function (function fb in FIG. 3) to the I/O system 203 in order to open an image data file within the HDD 105. An example of the name of the I/O function is open (“f name”). The argument f_name of this function is the name of a file to be read out. This function is reported to the file system 204 through a function fc in FIG. 3. The file system 204 exchanges file management data with the HDD 105 on an as-needed basis (see [III] HDD Read/Write Control of File Management Data, as described below).

(2) The file transfer control section 201 confirms the PM control section 202 as to whether there is an empty space in the PM_buffer 107a, and acquires a start address (&PM_buffer) and a transfer byte number (nBytes) of the PM_buffer 107a (according to a function fa in FIG. 3).

(3) Upon confirming the presence of empty space in the PM_buffer 107a, the file transfer control section 201 calls the I/O function to the I/O system 203 in order to fetch the image data of the file within the HDD 105 into the buffer1 103a (function fb in FIG. 3). An example of the I/O function is read (“f_name”, &buffer1, nBytes). The argument f_name of the function is the name of the image data file opened in the above step (1). The argument &buffer1 is a start address of the buffer1 103a that is a destination of data transfer, and nBytes is a read-out byte number for read-out from the HDD 105.

(4) The I/O system 203 calls a read instruction function to the file system 204 for read from the HDD 105 (function fc in FIG. 3).

(5) The file system 204 designates a sector address and a transfer sector number within the HDD 105 to the IDE driver 205, and calls a read instruction function for read from the HDD 105 (function fd in FIG. 3). An example of the name of the function is ideBlkRd (HddSecAdr, nBlks, &buffer1). The arguments of the function, HddSecAdr, nBlks, and &buffer1, indicate, respectively, the sector start address and transfer sector number of the HDD 105, which is the origin of transfer, and the start address of the memory, which is the destination of transfer.

The arguments, HddSecAdr and nBlks, are determined by the file system 204 on the basis of the file name and transfer byte number delivered from the file transfer control section 201 in the step (3). The argument &buffer1 is the &buffer1 delivered from the file transfer control section 201 as such.

(6) The IDE driver 205 transfers by DMA the data (with data addresses from HddSecAdr to nBlks) from the HDD 105 to the buffer2 103b (data transfer r1 in FIG. 3).

(7) The IDE driver 205 transfers data from the buffer2 103b to the buffer1 103a (data transfer r2 in FIG. 3). The start address of the buffer1 103a is delivered from the file system 204 in the above step (5).

(8) The file transfer control section 201 transfers data from the buffer1 103a to the PM_buffer 107a (transfer r3 in FIG. 3).

(9) The steps (2) to (8) are repeated according to the image data size.

(10) The file transfer control section 201 calls the I/O function to the I/O system 203 in order to finish the read of the image data file from the HDD 105 (function fb in FIG. 3). An example of the name of the function is close(“f_name”). This function is reported to the file system 204 through the function fc in FIG. 3. The file system 204 exchanges file management data with the HDD 105 on an as-needed basis (see [III] HDD Read/Write Control of File Management Data, as described below).

[III] HDD Read/Write Control of File Management Data

File management data is data necessary for the file system 204 to manage files in the HDD 105. The file management data is generated in the file system 204 in accordance with calls on various I/O functions (function fb in FIG. 3) to the I/O system 203. The file management data is written in the HDD 105 and read out of the HDD 105 to be used in the file system 204. The file management data is exchanged only between the file system 204 and the HDD 105, and it is not recognized in layers above the I/O system 203.

In the example shown in FIG. 3, data is transmitted between the buffer3 103c in the file system 204 and the HDD 105 according to HDD read/write instruction functions (ideBlkRd(), ideBlkRd()) delivered from the file system 204 to the IDE driver 205. The IDE driver 205 operates equally irrespective of the kind of data, whether the data to be treated is image data or file management data. Operations will now be described with respect to the case of writing file management data in the HDD 105 and the case of reading file management data from the HDD 105.

A. HDD Write of File Management Data

(1) The file system 204 calls an HDD write instruction function ideBlkWrt (HddSecAdr, nBlks, &buffer3) to the IDE driver 205 (function fd in FIG. 3). The arguments of the function, HddSecAdr, nBlks, and &buffer3, indicate, respectively, the sector start address of the HDD 105, which is the destination of transfer of file management data, the sector size of the file management data, and the start address of the buffer3 103c. Each argument is determined by the file system 204. The content of the buffer3 103c is the file management data generated by the file system 204.

(2) The IDE driver 205 transfers data of sector number nBlks from the buffer3 103c to the buffer2 103b of the IDE driver 205 (data transfer w4 in FIG. 3).

(3) The IDE driver 205 transfers by DMA the data from the buffer2 103b to the HDD 105 (data transfer w3 in FIG. 3). The sector start address of the HDD 105, which is the destination of transfer, is HddSecAdr delivered from the file system 204 in the above step (1).

B. HDD Read of File Management Data

(1) The file system 204 calls an HDD read instruction function ideBlkRd (HddSecAdr, nBlks, &buffer3) to the IDE driver 205 (function fd in FIG. 3). The arguments of the function, HddSecAdr, nBlks, and &buffer3, indicate, respectively, the sector start address of the HDD 105, which stores the file management data, the sector size of the file management data, and the start address of the buffer3 103c. Each argument is determined by the file system 204.

(2) The IDE driver 205 transfers by DMA the data (sector address from HddSecAdr to nBlks) from the HDD 105 to the buffer2 103b (data transfer r1 in FIG. 3).

(3) The IDE driver 205 transfers the data from the buffer2 103b to the buffer3 103c (data transfer r4 in FIG. 3). The start address of the buffer3 103c is delivered from the file system 204 in the above step (1).

The exchange of the file management data is performed, separately from the transfer of image data, in the image data file read/write sequence described in the above Sections [I] and [II] (in the above description, the timing of generation has not been clarified).

In general, when DMA transfer is carried out between the DMA device and the memory, it is necessary to use a cache-disable memory (hereinafter referred to as “non-cache memory”) in order to maintain consistency in caches. Once DMA transfer has been performed with a cache memory, the CPU 101 cannot recognize inconsistency in contents between the data cache 101a of CPU 101 and the cache memory. Thus, the consistency in caches cannot be maintained.

In the case of the example shown in FIG. 3, this problem can be solved if the IDE driver 205 assigns the buffer2 103b to the non-cache memory (the DMA device is HDD 105 in this example).

However, in the example shown in FIG. 3, the buffer2 103b always intervenes in the data exchange with the HDD 105. Consequently, the performance of transfer in the whole system is degraded by transfer between the buffer1 103a and buffer2 103b (data transfer w2, r2 in FIG. 3) and transfer between the buffer3 103c and buffer2 103b (data transfer w4, r4 in FIG. 3).

In order to improve the performance, there is a method in which the buffer2 103b is not used in the IDE driver 205. In this case, DMA transfer is performed directly between the HDD 105 and buffer1 103a and between the HDD 105 and buffer3 103c, and it becomes necessary to assign the buffer1 103a and buffer3 103c to non-cache memories in order to maintain consistency in caches. As regards the buffer1 103a, this is realized if the file transfer control section 201 designates a non-cache memory when it allocates the buffer 103a.

However, as regards the buffer3 103c to be allocated by the file system 204, the allocation of the buffer3 103c to the non-cache memory is not ensured when the file system 204, etc. prepared as a standard module of the OS is used. As a result, concerning the DMA transfer of file management data, there arises a problem in that the consistency of caches is not maintained (in normal cases the buffer3 103c is considered to be assigned to the cache memory in order to enhance the efficiency of memory access from the CPU 101).

In the case of image data transfer to the HDD 105, as illustrated in FIG. 3, the performance of transfer in the whole system is also degraded because the buffer1 103a of the file transfer control section 201 is used as a relay buffer.

The above problems may be summarized as follows. In a case where image data on a memory is converted to a file and then written in the HDD by DMA transfer, or in a case where an image data file in the HDD is read out by DMA transfer and developed on a memory, it is necessary to provide a relay buffer assigned to a non-cache memory in order to maintain consistency in caches.

However, to provide a relay buffer will degrade the transfer performance of the whole system. On the other hand, if DMA transfer with the HDD is performed without using the relay buffer in order to enhance the transfer performance, the consistency in caches cannot be maintained.

The object of the present invention is to solve the above problems and to efficiently perform HDD transfer of image data files while ensuring consistency in caches.

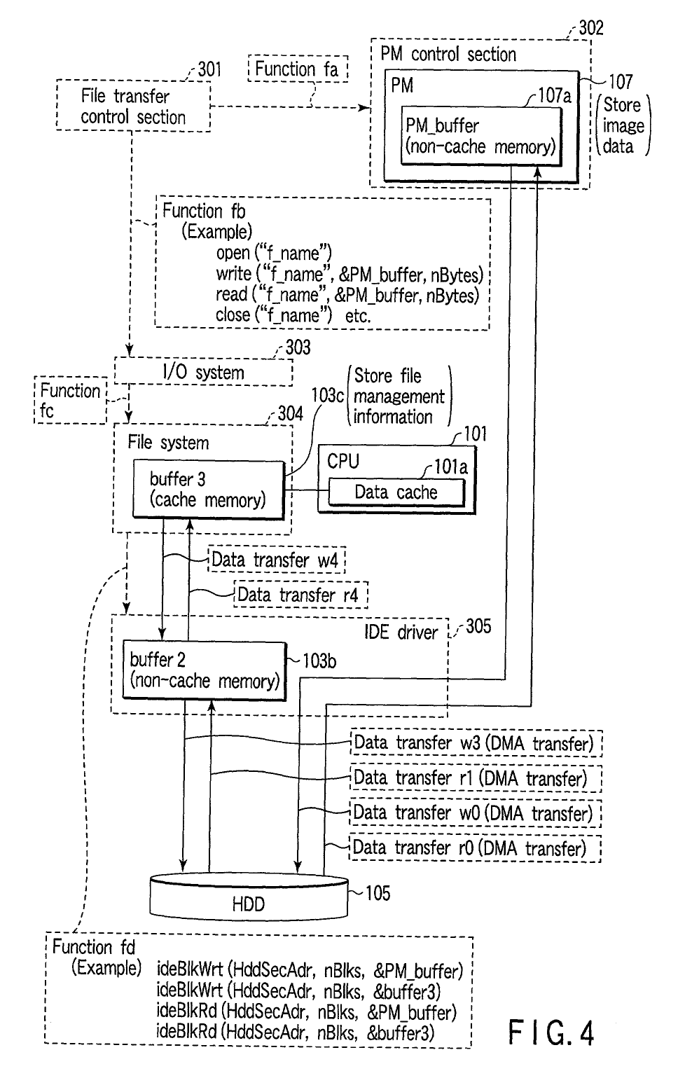

FIG. 4 shows a software configuration according to an embodiment of the present invention. In FIG. 4, blocks of broken lines indicate software modules, and blocks of solid lines indicate hardware. Hardware under control of the software modules is shown within the associated software module blocks.

The software modules comprise a file transfer control section 301, a PM control section 302, an I/O system 303, a file system 304 and an IDE driver 305.

The hardware comprises a CPU 101, a data cache 101a provided within the CPU 101, a HDD 105, a PM 107, a PM_buffer 107a provided within the PM 107, and a buffer1 103a, a buffer2 103b and a buffer3 103c provided within a main memory 103.

The file transfer control section 301 issues an instruction to convert various image data to files and to record them in the HDD 105, and an instruction to read out the image data files from the HDD 105.

The PM control section 302 manages data input to the PM 107 and data output from the PM 107, and performs data compression/decompression within the PM 107.

The I/O system 303 is a standard module provided in the OS of the MFP for access to various I/O devices.

The file system 304 is an OS-specific device that is required where the I/O device is a block device such as HDD 105, as in the present embodiment.

The IDE driver 305 is a device driver for directly controlling the HDD 105.

The modules requiring development by device designers according to the original specifications of the MFP are the file transfer control section 301, PM control section 302, and IDE driver 305. The I/O system 303 and file system 304 are standard modules prepared by the OS of the MFP.

In FIG. 4, the buffer2 (non-cache memory) 103b and buffer3 (cache memory) 103c are used, respectively, by the modules: the IDE driver 305 and file system 304. These buffer2 103b and buffer3 103c are assigned within the main memory 103.

In FIG. 4, the PM_buffer 107a is a buffer used for data transfer by the PM 107 with the outside, and it is assigned to an area of the PM 107.

The embodiment shown in FIG. 4 differs from the prior art of FIG. 3 in the following points (1) to (4).

(1) The PM_buffer 107a is assigned to the non-cache memory.

(2) The IDE driver 305 has means for determining whether the memory at the destination (or origin) of transfer, which is provided by the file system 304, is a cache memory or a non-cache memory. For example, the cache memory area and non-cache memory area are assigned to different virtual addresses (addresses as viewed from the software module) by the OS. The determination is thus possible on the basis of the transfer destination (origin) address value delivered from the file system 304.

(3) If the transfer destination (origin) memory delivered from the file system 304 is the cache memory, the IDE driver 305 uses the buffer2 103b assigned to the non-cache memory as the relay buffer as in usual cases and uses it as the destination of DMA transfer with the HDD 105. If the transfer destination (origin) memory delivered from the file system 304 is the non-cache memory, DMA transfer is directly performed with the HDD 105.

(4) The file transfer control section 301 does not perform data transfer with the PM control section 302. At the time of calling read/write functions to the I/O system 303, the start address (&PM_buffer) of the PM buffer 107a is delivered as such.

Control operations of the embodiment of the present invention will now be described.

[I] HDD Write Control of Image Data Files

(1) The file transfer control section 301 calls an I/O function (function fb in FIG. 4) to the I/O system 303 in order to generate and open within the HDD 105 a file for saving image data. An example of the name of the I/O function is open(“f_name”). The argument f_name of this function is the name of a file to be generated and opened. This function is reported to the file system 304 through a function fc shown in FIG. 4. The file system 304 exchanges file management data with the HDD 105 on an as-needed basis (see the HDD Read/Write Control of File Management Data, as described below).

(2) The file transfer control section 301 confirms the PM control section 302 as to whether image data to be written in the HDD 105 has been prepared in the PM buffer 107a, and acquires a start address (&PMbuffer) and a transfer byte number (nBytes) of the PM_buffer 107a (according to a function fa in FIG. 4).

(3) Upon confirming the preparation of data in the PM buffer 107a, the file transfer control section 301 calls the I/O function to the I/O system 303 in order to write in the HDD 105 the image data within the PM buffer 107a (function fb in FIG. 4). An example of the I/O function is write(“f_name”, &PM_buffer, nbytes). The argument f_name of the function is the name of a file within the HDD 105 that is a destination of data transfer. The argument &PM_buffer is a start address of the origin of transfer, and nBytes is a transfer byte number for transfer to the HDD 105. The file “f name” is generated and opened in the above step (1), and the &PM_buffer and nBytes are acquired in the above step (2) by the PM control section 302.

(4) The I/O system 303 calls an HDD write instruction function to the file system 304 (function fc in FIG. 4).

(5) The file system 304 designates a sector address and a transfer sector number within the HDD 105 to the IDE driver 305, and calls a write instruction function for write to the HDD 105 (function fd in FIG. 4). An example of the name of the function is ideBlkwrt (HddSecAdr, nBlks, &PM_buffer). The arguments of the function, HddSecAdr, nBlks, and &PM_buffer, indicate, respectively, the sector start address and transfer sector number of the HDD 105, which is the destination of transfer, and the start address of the memory, which is the origin of transfer. The arguments, HddSecAdr and nBlks, are determined by the file system on the basis of the file name and transfer byte number delivered from the file transfer control section 301 in the step (3). The argument &PM_buffer is the &PM buffer delivered from the file transfer control section 301 as such.

(6) The IDE driver 305 determines that the &PM_buffer is a non-cache memory address, and directly DMA-transfers data of the PM_buffer 107a to the HDD 105 (data transfer w0 in FIG. 4).

(7) The steps (2) to (6) are repeated according to the image data size.

(8) The file transfer control section 301 calls the I/O function to the I/O system 303 in order to finish the filing of image data (function fb in FIG. 4). An example of the name of the function is close(“f name”). This function is reported to the file system 304 through the function fc in FIG. 4. The file system 304 exchanges file management data with the HDD 105 on an as-needed basis (see the HDD Read/Write Control of File Management Data, as described below).

[II] HDD Read Control of Image Data Files

(1) The file transfer control section 301 calls an I/O function (function fb in FIG. 4) to the I/O system 303 in order to open an image data file within the HDD 105. An example of the name of the I/O function is open (“f name”). The argument f_name of this function is the name of a file to be read out. This function is reported to the file system 304 through a function fc in FIG. 4. The file system 304 exchanges file management data with the HDD 105 on an as-needed basis (see the HDD Read/Write Control of File Management Data, as described below).

(2) The file transfer control section 301 confirms the PM control section 302 as to whether there is an empty space in the PM_buffer 107a, and acquires a start address (&PM_buffer) and a transfer byte number (nBytes) of the PM_buffer 107a (according to a function fa in FIG. 4).

(3) Upon confirming the presence of empty space in the PM_buffer 107a, the file transfer control section 301 calls the I/O function to the I/O system 303 in order to fetch the image data of the file within the HDD 105 into the PM_buffer 107 (function fb in FIG. 4). An example of the I/O function is read (“f_name”, &PM buffer, nBytes). The argument f_name of the function is the name of the image data file opened in the above step (1). The argument &PM_buffer is a start address of the PM_buffer 107a that is a destination of transfer, and nBytes is a read-out byte number for read-out from the HDD 105.

(4) The I/O system 303 calls an HDD read instruction function to the file system 304 (function fc in FIG. 4).

(5) The file system 304 designates a sector address and a transfer sector number within the HDD 105 to the IDE driver 305, and calls a read instruction function for read from the HDD 105 (function fd in FIG. 4). An example of the name of the function is ideBlkRd (HddSecAdr, nBlks, &PM_buffer). The arguments of the function, HddSecAdr, nBlks, and &PM_buffer, indicate, respectively, the sector start address and transfer sector number of the HDD, which is the origin of transfer, and the start address of the memory, which is the destination of transfer. The arguments, HddSecAdr and nBlks, are determined by the file system 304 on the basis of the file name and transfer byte number delivered from the file transfer control section 301 in the step (3). The argument &PM_buffer is the &PM buffer delivered from the file transfer control section 301 as such.

(6) The IDE driver 305 determines that the &PM_buffer is a non-cache memory address, and directly DMA-transfers the data (with sector addresses HddSecAdr to nBlks) of the HDD 105 to the PM_buffer 107a (data transfer r0 in FIG. 4).

(7) The steps (2) to (6) are repeated according to the image data size.

(8) The file transfer control section 301 calls the I/O function to the I/O system 303 in order to finish the read of the image data file from the HDD 105 (function fb in FIG. 4). An example of the name of the function is close(“f_name”). This function is reported to the file system through the function fc in FIG. 4. The file system 304 exchanges file management data with the HDD 105 on an as-needed basis (see HDD Read/Write Control of File Management Data, as described below).

[III] HDD Read/Write Control of File Management Data

The file management data handled by the file system 304 is transferred between the buffer3 103c assigned by the file system 304 to the cache memory and the HDD 105. Thus, as in the prior art, DMA transfer is carried out using the buffer2 103b assigned by the IDE driver 305 to the non-cache memory as the relay buffer.

As has been described above, according to the embodiment of the invention, the conventional transfer system is adopted for the file management data, but the image data is directly transferred by DMA between the HDD and the PM. Therefore, the image file transfer performance of the whole system is enhanced, and the problem of loss of consistency in caches due to DMA transfer is solved.

In the above-described embodiment, image data is stored in the page memory (PM), but the invention is equally applicable to the case where the image data is stored in the main memory.

What is claimed is:

1. An image forming apparatus having a memory that stores image data, and a hard disk drive that stores an image data file, the apparatus comprising:
designation means for designating a memory area of said memory when data is transferred between the memory and the hard disk drive;
a relay buffer provided in the memory;
determination means for determining whether the memory area designated by the designation means is a cache memory or a non-cache memory;
first transfer means for controlling, when the determination means has determined that the memory area is the cache memory, DMA transfer between the hard disk drive and the relay buffer, and data transfer between the relay buffer and the designated memory area; and
second transfer means for controlling, when the determination means has determined that the memory area is the non-cache memory, DMA transfer between the hard disk drive and the designated memory area.

2. An image forming apparatus according to claim 1, wherein said memory is a page memory or a main memory.

3. An image forming apparatus according to claim 1, wherein said designation means issues an instruction to convert various image data to a file and to record the file in the hard disk drive, and an instruction to read out the file of the image data from the hard disk drive.

4. An image forming apparatus according to claim 1, wherein said designation means effects the determination on the basis of an address value of the designated memory area assigned to a different virtual address by an operating system.

5. An image forming apparatus according to claim 1, wherein said first transfer means and said second transfer means are device drivers for directly controlling the hard disk drive.

6. An image forming apparatus according to claim 1, wherein said second transfer means performs a control to DMA transfer the image data stored in the hard disk drive to the designated memory area, or a control to DMA transfer the image data stored in the designated memory area to the hard disk drive.

7. An image forming apparatus having a memory that stores image data, and a hard disk drive that stores an image data file, the apparatus comprising:
a buffer serving as a non-cache memory set in the memory;
designation means for designating a memory area of the buffer when data is transferred between the memory and the hard disk drive;
determination means for determining whether the memory area designated by the designation means is a cache memory or a non-cache memory; and
transfer means for controlling, when the determination means has determined that the memory area is the non-cache memory, DMA transfer between the hard disk drive and the buffer.

8. An image forming apparatus according to claim 7, wherein said memory is a page memory that has an area capable of storing image information of plural pages and is able to store data of compressed image information in units of a page.

9. An image forming apparatus according to claim 7, wherein said transfer means effects a control to DMA transfer the image data stored in the hard disk drive to the buffer, or a control to DMA transfer the image data stored in the buffer to the hard disk drive.

10. A hard disk drive data transfer method for an image forming apparatus having a memory that stores image data, and a hard disk drive that stores an image data file, the method comprising:
designating a memory area of said memory when data is transferred between the memory and the hard disk drive;
determining whether the designated memory area is a cache memory or a non-cache memory;
performing, when the memory area is determined to be the cache memory, DMA transfer between the hard disk drive and a relay buffer preset in the memory, and data transfer between the relay buffer and the designated memory area; and
performing, when the memory area is determined to be the non-cache memory, DMA transfer between the hard disk drive and the designated memory area.
